(19) United States
(12) Patent Application Publication
(10) Pub. No.: US 2026/0331634 A1
(43) Pub. Date: Oct. 22, 2026

(54) OVERMOLDED COLD PLATE BATTERY TRAY

(71) Applicant: GM GLOBAL TECHNOLOGY OPERATIONS LLC, Detroit, MI (US)

(72) Inventor: Michael Apone, Fraser, MI (US)

(73) Assignee: GM GLOBAL TECHNOLOGY OPERATIONS LLC, Detroit, MI (US)

(21) Appl. No.: 19/182,915

(22) Filed: Apr. 18, 2025

(51) Int. Cl. H01M 10/6556; H01M 10/613; H01M 10/625; H01M 10/6563; H01M 10/6568; H01M 50/249

(52) U.S. Cl. CPC H01M 10/6556; H01M 10/613; H01M 10/625; H01M 10/6563; H01M 10/6568; H01M 50/249; H01M 2220/20

(57) ABSTRACT

Battery enclosure systems and methods for cooling batteries are provided. A method for cooling a battery includes locating a metal cold plate in a mold, wherein the metal cold plate includes an internal channel; filling the mold with resin and cooling to form an overmolded battery tray including an outer part surrounding the metal cold plate; wherein the overmolded battery tray has a bottom surface formed by the outer part and an upper surface formed by the metal cold plate; connecting the internal channel with a coolant supply; locating the battery on the metal cold plate; and attaching a cover to the overmolded battery tray to enclose an internal volume, wherein the battery is in the internal volume.

### INTRODUCTION

The disclosure relates to motor vehicle battery systems, and more specifically to systems and methods for enclosing and cooling battery packs.

Electrochemical battery packs are used in a host of battery electric systems. Aboard an electric vehicle (EV) in particular, a high-energy propulsion battery pack is arranged on a direct current (DC) voltage bus, with the propulsion battery pack having an application-suitable number of cylindrical, prismatic, or pouch-style electrochemical battery cells. The DC voltage bus ultimately powers one or more electric traction motors and associated power electronic components during battery discharging modes. The same DC voltage bus conducts a charging current to constituent battery cells of the battery pack during battery charging modes.

Propulsion battery packs for use with electric vehicles and other battery electric systems typically utilize a lithium-based or nickel-based battery chemistry. In lithium-ion battery cells, for instance, the movement of electrons and lithium ions produces electricity for use in powering the above-noted electric traction motor(s). Charging and discharging of the battery cells is accompanied by a discharge of heat. The generated heat in turn must be dissipated from the battery cells, e.g., via circulation of battery coolant, cooling plates, or cooling fins. Under rare conditions, battery cell damage, age, or degradation could lead to the generation of heat in a battery cell or battery pack at a rate exceeding an existing cooling capability. Such a condition is referred to both herein and in the art as thermal runaway.

Accordingly, there is a need for systems and methods for enclosing EV batteries which protect adjacent vehicle components from the heat emitted from the battery, while reducing hardware cost and complexity, improving reliability, and offering improved function and redundancy. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a method for cooling a battery includes locating a metal cold plate in a mold, wherein the metal cold plate includes an internal channel; filling the mold with resin and cooling to form an overmolded battery tray including an outer part surrounding the metal cold plate; wherein the overmolded battery tray has a bottom surface formed by the outer part and an upper surface formed by the metal cold plate; connecting the internal channel with a coolant supply; locating the battery on the metal cold plate; and attaching a cover to the overmolded battery tray to enclose an internal volume, wherein the battery is in the internal volume.

In certain embodiments, the method further includes forming the metal cold plate via a brazing process.

In certain embodiments of the method, the metal cold plate includes a coolant inlet and a coolant outlet; the internal channel extends from the coolant inlet to the coolant outlet; and after forming the overmolded battery tray, the internal channel extends through the outer part, extends out of the outer part to the coolant inlet, and extends out of the outer part to the coolant outlet.

In certain embodiments of the method, the outer part includes sidewalls and a bottom base member interconnecting the sidewalls, wherein the internal channel extends through the bottom base member, extends out of the bottom base member to the coolant inlet, and extends out of the bottom base member to the coolant outlet.

In certain embodiments of the method, the outer part includes sidewalls and a bottom base member interconnecting the sidewalls, wherein the internal channel extends through and out of one of the sidewalls to the coolant inlet and extends through and out of one of the sidewalls to the coolant outlet.

In certain embodiments of the method, the resin includes a glass fiber reinforced thermoset or thermoplastic.

In certain embodiments of the method, the metal cold plate includes a first metal cold plate including a first internal channel and a second metal cold plate including a second internal channel; the battery includes a first battery and a second battery; and locating the battery on the metal cold plate includes locating the first battery on the first metal cold plate and locating the second battery on the second metal cold plate.

In certain embodiments of the method, connecting the internal channel with a coolant supply includes connecting the first internal channel with the coolant supply and connecting the second internal channel with the coolant supply.

In certain embodiments of the method, connecting the internal channel with a coolant supply includes interconnecting the first internal channel and the second internal channel and connecting the first internal channel with the coolant supply.

In certain embodiments of the method, filling the mold with resin and cooling forms the outer part with a central wall located between the first metal cold plate and the second metal cold plate.

In another embodiment, a battery enclosure system is provided and includes a tray including an overmolded outer part and a metal cold plate inner part, wherein the overmolded outer part defines an exterior surface of the tray and an annular portion of an interior surface of the tray, wherein the metal cold plate inner part defines a central portion of the interior surface of the tray, wherein the metal cold plate inner part defines a coolant flow channel extending from a coolant inlet to a coolant outlet, and wherein the coolant inlet and the coolant outlet extend through the overmolded outer part to the exterior surface of the tray; a cover sealed to the tray to define an enclosed chamber; and a battery located in the enclosed chamber in contact with the metal cold plate inner part.

In certain embodiments of the battery enclosure system, the metal cold plate inner part is a first metal cold plate inner part; the central portion is a first central portion; the battery is a first battery; the tray includes a second metal cold plate inner part defining a second central portion of the interior surface of the tray; and the battery enclosure system further includes a second battery located in the enclosed chamber in contact with the second metal cold plate inner part.

In certain embodiments of the battery enclosure system, the first metal cold plate inner part is formed with the coolant inlet; the second metal cold plate inner part is formed with the coolant outlet; and the tray further includes a coolant channel connecting the first metal cold plate inner part and the second metal cold plate inner part.

In certain embodiments of the battery enclosure system, the coolant inlet is a first coolant inlet; the coolant outlet is a first coolant outlet; the first metal cold plate inner part is formed with the first coolant inlet and the first coolant outlet; the second metal cold plate inner part is formed with a second coolant inlet and a second coolant outlet; and the second coolant inlet and the second coolant outlet extend through the overmolded outer part to the exterior surface of the tray.

In certain embodiments of the battery enclosure system, the overmolded outer part includes glass fiber reinforced weaves.

In another embodiment, a vehicle is provided and includes a battery; a coolant supply; and a battery enclosure system including a cover having a cover perimeter surface; and a tray having a tray perimeter surface, wherein the tray perimeter surface is connected to the cover perimeter surface and defines an enclosed chamber, wherein the battery is located in the enclosed chamber, and wherein the tray includes an overmolded outer part and a metal cold plate inner part, wherein the overmolded outer part defines an exterior surface of the tray and an annular portion of an interior surface of the tray, wherein the metal cold plate inner part defines a central portion of the interior surface of the tray, wherein the metal cold plate inner part defines a coolant flow channel extending from a coolant inlet to a coolant outlet, and wherein the coolant inlet and the coolant outlet extend through the overmolded outer part and are connected to the coolant supply at a location outside of the enclosed chamber.

In certain embodiments of the vehicle, the metal cold plate inner part is a first metal cold plate inner part; the central portion is a first central portion; the battery is a first battery; the tray includes a second metal cold plate inner part defining a second central portion of the interior surface of the tray; and the battery enclosure system further includes a second battery located in the enclosed chamber in contact with the second metal cold plate inner part.

In certain embodiments of the vehicle, the first metal cold plate inner part is formed with the coolant inlet; the second metal cold plate inner part is formed with the coolant outlet; and the tray further includes a coolant channel connecting the first metal cold plate inner part and the second metal cold plate inner part.

In certain embodiments of the vehicle, the coolant inlet is a first coolant inlet; the coolant outlet is a first coolant outlet; the first metal cold plate inner part is formed with the first coolant inlet and the first coolant outlet; the second metal cold plate inner part is formed with a second coolant inlet and a second coolant outlet; and the second coolant inlet and the second coolant outlet extend through the overmolded outer part to the exterior surface of the tray.

In certain embodiments of the vehicle, the overmolded outer part includes glass fiber reinforced weaves.

### DESCRIPTION OF THE DRAWINGS

The present disclosure will hereinafter be described in conjunction with the following drawing figures, wherein like numerals denote like elements, and wherein:

FIG. 1 is a schematic, perspective view of an electric vehicle with a cut-away section to reveal a battery housed in a battery enclosure system with an interconnected tray and cover in accordance with exemplary embodiments.

FIG. 2 is a cross sectional schematic diagram depicting the battery enclosure system, such as shown in FIG. 1, in accordance with exemplary embodiments.

FIG. 3A is a perspective schematic view of the battery tray of the battery enclosure system of FIG. 2, in accordance with exemplary embodiments.

FIG. 3B is a cross sectional schematic diagram depicting the battery tray of FIG. 3A taken along line 3-3 in FIG. 3A, with batteries and coolant supply, in accordance with exemplary embodiments.

FIG. 4A is a perspective schematic view of the battery tray of the battery enclosure system of FIG. 2, in accordance with exemplary embodiments.

FIG. 4B is a cross sectional schematic diagram depicting the battery tray of FIG. 4A taken along line 4-4 in FIG. 4A, with batteries and coolant supply, in accordance with exemplary embodiments.

FIG. 5 is a cross sectional schematic diagram of the battery tray of the battery enclosure system of FIG. 2, in accordance with exemplary embodiments.

FIG. 6 is a flow chart illustrating a method for cooling a battery, in accordance with certain embodiments.

FIG. 7 is a schematic illustrating various operations of the method of FIG. 6, in accordance with certain embodiments.

FIG. 8 is a perspective view of a cold plate inner part of a battery tray, in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term “module” refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

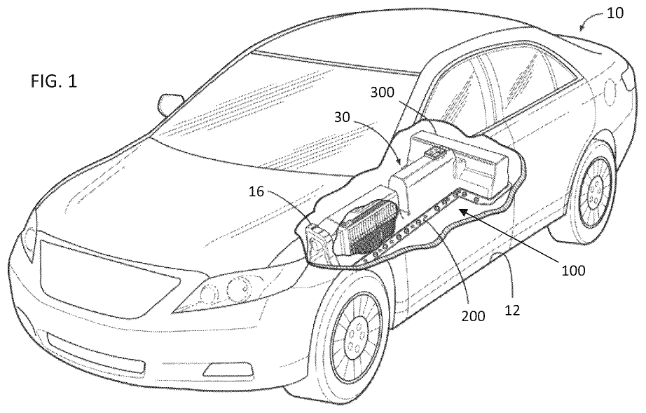

Referring to the drawings, wherein like reference numbers correspond to like or similar components wherever possible throughout the several figures, an electric vehicle 10 having a Rechargeable Energy Storage System (RESS) or battery 30, is shown in FIG. 1. The term “battery” used alone herein may refer to a battery module, battery cell or cell stack. The electric vehicle 10 further includes a battery enclosure system 100 for enclosing the battery 30. The term “battery pack” used alone may refer to a battery and the battery enclosure system the battery is housed within.

The battery enclosure system 100 includes a battery tray 200. The battery enclosure system 100 further include a battery cover 300 that extends over and around the battery 30. The battery tray 200 and cover 300 may protect the battery 30 from being damaged, as well as provide electrical insulation to the high voltage of the battery 30.

The electric vehicle 10 includes a vehicle body 12, and the battery enclosure system 100 may be indirectly or directly mounted to the body 12.

The electric vehicle 10 may also include a battery disconnect unit 16, which is connected to the battery 30 and provides electrical communication between the battery 30 and an electrical system (not shown) of the electric vehicle 10.

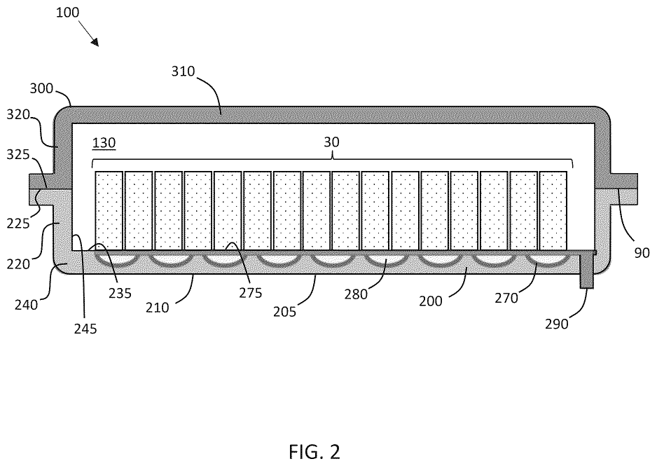

FIG. 2 is a cross-sectional schematic illustrating an exemplary embodiment of the battery enclosure system 100 of FIG. 1. FIG. 2 illustrates that the battery tray 200 of the battery enclosure system 100 includes a base member 210 that extends laterally to sidewalls 220. As shown, the sidewalls 220 extend upward to and terminate at a surface 225.

As shown in FIG. 2, the battery cover 300 includes a base member 310 that extends laterally to sidewalls 320. As shown, the sidewalls 320 extend downward to and terminate at a surface 325. The battery cover 300 may be a plastic and/or non-metal material and/or may be formed from a composite material. In certain embodiments, the battery cover 300 may be a metal such as steel or aluminum or other suitable material.

The battery tray 200 and battery cover 300 may be fixed and/or sealed to one another at an interface 90 formed by surfaces 225 and 325. When fixed together, the battery tray 200 and battery cover 300 enclose an enclosed chamber or internal volume 130. As shown, the battery 30, including a plurality of individual battery cells, is located in the enclosed chamber 130.

In embodiments herein, the battery tray 200 is formed as a two-part component including an outer part 240 and an inner part 270.

The outer part 240 forms an annular portion 245 of the interior surface 235 of the battery tray 200, i.e., the surface bounding and defining the enclosed chamber 130. The outer part 240 further forms the surfaces 225 of the battery tray 200 that contact the battery cover 300 when sealed together. Also, the outer part 240 forms the exterior surface 205 of the battery tray 200. i.e., the surface of the battery tray 200 that is uncovered or exposed when the battery tray 200 and battery cover 300 are sealed together, including the bottom surface of the battery tray 200.

In certain embodiments, the outer part 240 is formed from a glass fiber reinforced thermoset or thermoplastic. For example, the outer part 240 may be formed by injection or compression molding of a resin.

The inner part 270 of the battery tray 200 is a thermally conductive cold plate configured to transfer heat away from the battery 30. For example, the inner part 270 may be a metal, such as aluminum. The inner part 270 may be a brazed cold plate. As shown, the inner part forms a central surface portion 275 of the interior surface 235, surrounded by the annular portion formed by the outer part 240. The central surface portion 275 may be planar. As shown, the battery 30 may be positioned directly on the central surface portion 275 of surface 235, formed by the inner part 270.

As shown, the inner part 270 defines a coolant flow pipe or channel 280. The coolant flow channel 280 is located below the central surface portion 275 and extends from the central surface portion 275 into the outer part 240.

The inner part 270 is formed with and includes ports or openings 290, one of which is shown in FIG. 2. The openings 290 are in fluid communication with the coolant flow channel 280, and are provided as inlets and outlets for the coolant flow channel 280. In the embodiment of FIG. 2, the opening 290 is located below the bottom exterior surface 205, such that the coolant flow channel 280 extends downward from the central surface portion 275, through and out of the base member 210 of the outer part 240. In other embodiments, the opening 290 is located laterally adjacent to the sidewall 220 such that the coolant flow channel 280 extends outward from the central surface portion 275, through and out of the sidewall 220 of the outer part 240.

By locating the openings 290 outside of the battery enclosure assembly 100, i.e., not within the enclosed chamber 130, access to the connection between the openings 290 and a coolant hose is facilitated.

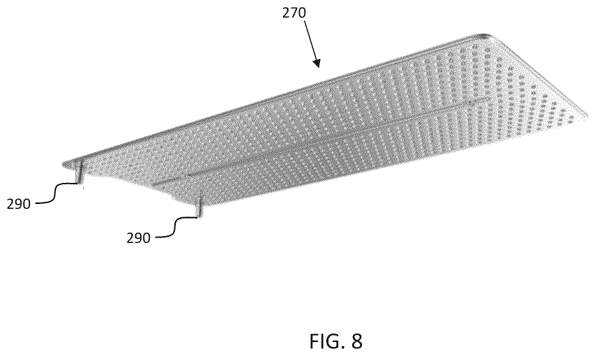

FIG. 8 provides a perspective view of an embodiment of a cold plate inner part 270. As shown, the cold plate inner part 270 includes two openings 290, i.e., an inlet opening and an outlet opening. The coolant flow channel 280, not shown in FIG. 8, extends between and is in fluid communication with the openings 290.

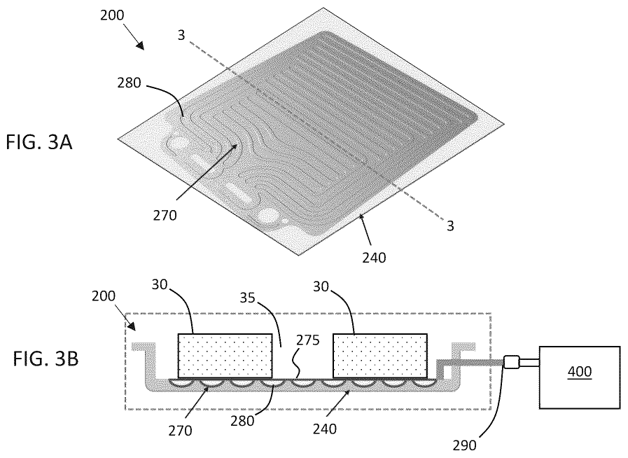

FIG. 3A provides a perspective view of an embodiment of a battery tray 200 in the form of an overmolded cold plate. In FIG. 3A, the coolant flow channel 280 is visible through the upper surface 275 of the cold plate 270.

FIG. 3B provides a cross-sectional view of the battery tray 200 taken along line 3-3 of the perspective view. Further, FIG. 3B indicates schematically that the battery tray 200 may be in fluid connection with a coolant supply 400, and that a plurality of batteries 30 may be located on the battery tray 200.

Specifically, in the embodiment of FIG. 3B a single cold plate/inner part 270 is overmolded with a single plastic outer part 240. As shown, two separate batteries 30, which may include multiple battery cells, are located on the cold plate/inner part 270. The two batteries 30 are separated by a gap 35. As shown, the surface 275 of the cold plate/inner part 270 is uncovered in the gap 35.

Further, FIG. 3B illustrates an embodiment in which the coolant flow channel 280 extends through the sidewall 220 of the outer part 240 to opening 290, which is located laterally adjacent to the outer part 240, rather than below the outer part 240 as shown in FIG. 2. As further indicated, the opening 290 is connected to a coolant supply 400 so that coolant may be flowed through the coolant flow channel 280 to remove heat from the batteries 30.

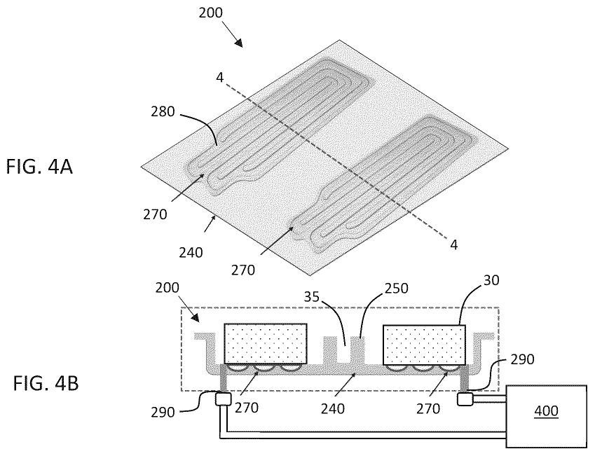

FIGS. 4A and 4B illustrate another embodiment. FIG. 4A provides a perspective view of an embodiment of a battery tray 200 in the form of an overmolded cold plate. In FIG. 4A, the coolant flow channel 280 is visible through the upper surface 275 of the cold plate 270.

FIG. 4B provides a cross-sectional view of the battery tray 200 taken along line 4-4 of the perspective view. Further, FIG. 4B indicates schematically that the battery tray 200 may be in fluid connection with a coolant supply 400, and that a plurality of batteries 30 may be located on the battery tray 200.

Further, in the embodiment of FIG. 4B a two separate cold plate/inner parts 270 are overmolded with a single plastic outer part 240. As shown, two separate batteries 30, which may include multiple battery cells, are located on the cold plate/inner parts 270, i.e., one battery 30 on each cold plate/inner part 270. It is contemplated that more than one battery 30 may be located on each cold plate/inner part 270.

As shown in FIG. 4B, the two batteries 30 and the two cold plate/inner parts 270 are separated by a gap 35. Further, the outer part 240 is formed with a vertical wall 250 which may be perpendicular to the surface 275. The vertical wall 250 may provide structural support to the battery tray 200.

Further, FIG. 4B illustrates an embodiment in which the cold plate/inner parts 270 include distinct coolant flow channels 280. Specifically, each coolant flow channel 280 is connected independently to the coolant supply 400 through a dedicated opening 290. Thus, the coolant flow channels 280 are not connected to one another within the battery tray 200.

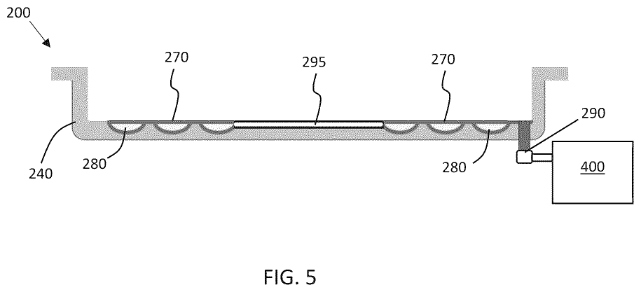

FIG. 5 illustrates another embodiment of a battery tray 200, similar to the embodiment of FIG. 4B. As shown, the battery tray 200 includes two cold plate/inner parts 270 that are separated by a gap 35. However, in FIG. 5, an internal connection pipe or channel 295 interconnects the coolant flow channels 280 of the two cold plate/inner parts 270. Therefore, one opening 290 may be connected to the coolant supply 400 to flow coolant fluid through the coolant flow channels 280 of both cold plate/inner parts 270. It is noted that in FIG. 5, and the other Figures, a second opening 290 may be provided at a location not shown in the cross-sectional view to serve as an outlet for warmed coolant fluid.

While the Figures illustrates various features, it is noted that an embodiment may include a combination of features not illustrated in a single Figure.

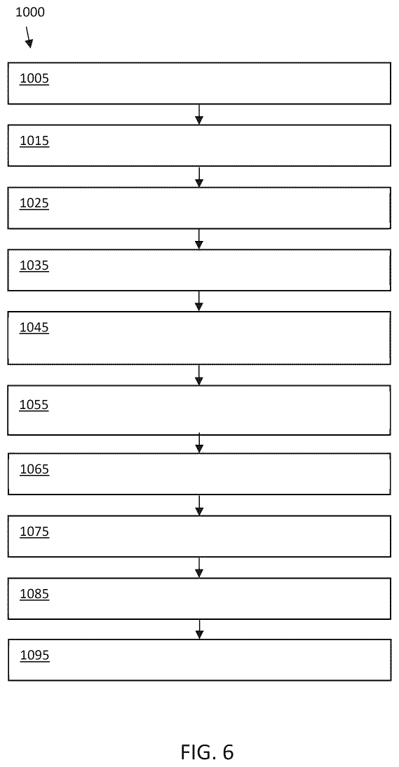

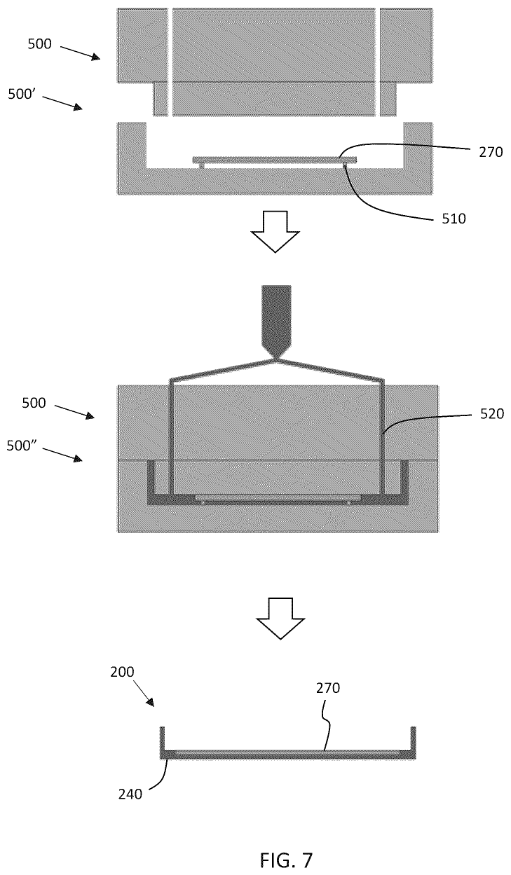

FIG. 6 illustrates a method 1000 for cooling a battery and FIG. 7 illustrates schematically several operations in the method 1000.

Cross-referencing FIGS. 6 and 7, method 1000 includes, at operation 1005, forming or providing a cold plate 270. For example, operation 1005 may include forming a coolant flow channel 280 and joining the coolant flow channel 280 to a planar member having a surface 275. The coolant flow channel 280 and planar member may be formed from a same material. For example, the coolant flow channel 280 and planar member may be aluminum. The coolant flow channel 280 and planar member may be joined via a brazing process.

At operation 1015, method 1000 includes locating the cold plate 270 in a mold 500. As shown, the mold 500 is configured in an open state 500′ and the cold plate 270 may be positioned onto guide members 510. In certain embodiments, operation 1015 includes locating glass fiber reinforced weaves in the mold 500. For example, organosheets may be located at desired locations of the to-be-formed plastic outer part. In certain embodiments, carbon fiber weaves may be used.

Method 1000 continues at operation 1025 with closing the mold 500, i.e., moving the mold 500 to a closed state 500″. Further operation 1025 includes filling the mold with flowable resin 520. In certain embodiments, the flowable resin 520 may include glass fibers or carbon fibers. The flowable resin 520 may be a thermoplastic or thermoset material.

At operation 1035, method 1000 includes cooling the mold 500 and resin 520 to form an overmolded battery tray 200, including the cold plate 270 as an inner part and the molded resin as an outer part 240 covering the bottom of the cold plate 270, surrounding the sides of the cold plate 270, and leaving the upper surface 275 of the cold plate uncovered for thermal contact with batteries.

As shown, at operation 1045, the overmolded battery tray 200 is removed from the mold 500.

The method 1000 may continue at operation 1055 with positioning the overmolded battery tray 200 in a vehicle 10, as indicated in FIG. 1.

Further, the method 1000 may include, at operation 1065, connecting the overmolded battery tray 200 to a coolant supply 400, as indicated in FIGS. 3B, 4B, and 5. Specifically, an opening 290 of the coolant flow channel 280 is connected to the coolant supply 400.

Method 1000 may continue at operation 1075 with locating a battery or batteries 30 on the surface 275 of the metal cold plate 270 of the battery tray 200, as indicated in FIGS. 2, 3B, and 4B.

Further, method 1000 may include, at operation 1085, attaching a battery cover 300 to the battery tray 200 to enclose the battery or batteries 30 within an internal volume 130, as indicated by FIG. 2.

Method 1000 may include, at operation 1095, operating a vehicle using power from the battery 30 while cooling the battery 30 through the battery tray 200 by flowing coolant fluid from the coolant supply 400 through the coolant flow channel 280. Operation 1095 may further include protecting the metal cold plate 270 from impacts with debris or structures located below the battery tray 200. Specifically, the plastic outer part 240 blocks impact to the bottom of the cold plate 270, while the battery cover 300 prevents any debris or structures from entering the enclosed chamber 130 to impact the upper surface 275 of the cold plate 270.

Embodiments herein provide a single-step process to manufacture a battery tray including an integrated cold plate. Specifically, after the cold plate is provided, the molding process forms the remaining portion of the battery tray from resin around the cold plate without requiring any positioning, datuming, or holding processes while performing operations to attach the cold plate to the resin molded part, i.e., plastic tray portion.

In certain embodiments, an overmolded brazed cold plate is protected from impacts from below the battery tray by the resin molded part.

With the design provided by embodiments herein, the bottom of the battery 30 rests on the cold plate 270 and, with the orientation of the battery 30, the bottom of the battery 30 faces the ground below the vehicle 10. In other words, the force of gravity is a normal force holding the bottom of the battery 30 on the surface 275 of the cold plate 270.

In certain embodiment, the opening 290 of the coolant flow channel 280, formed by the metal of the cold plate 270, is located outside of the overmolded plastic part 240. In other words, the metal coolant flow channel 280 extends through the overmolded plastic part 240 to an external location. As described above, the metal coolant flow channel 280 may extend though the bottom base member 210 or through a sidewall 220 of the overmolded plastic part 240. As a result, the connection between the metal coolant flow channel 280 and a coolant supply 400 is located outside of the battery enclosure system 100. Connection, disconnection and servicing of the connection of the metal coolant flow channel 280 and the coolant supply 400 may be performed while the battery cover 300 encloses the internal volume 130 of the battery enclosure system 100.

Embodiments herein use an overmolded cold plate as the base of a RESS or battery tray. The tray may have a single cold-plate for pack-level cooling, or multiple cold plates for individually-cooled cell stacks. In either configuration, the cold plate is over-molded and used as the base of the RESS tray.

Embodiments herein provide a method for manufacturing a RESS or battery tray with an integrated cold plate while still using a brazed cold plate construction that is proven to be reliable and cost-effective, with minimal cost or sealing reliability issues.

Embodiments of the manufacturing process yield an integrated cold plate as part of a RESS tray without any additional fastening/connection steps. The method simply molds the RESS tray as intended, and upon molding the cold plate is already fully functional. Alternative approaches to highly integrated cold plates are multi-step assembly processes that greatly increase cost.

Embodiments herein provide for overmolding the bottom of a metal cold plate that is the base of a RESS tray to protect it from underbody debris or stone impingement.

Embodiments herein may use a brazed cold plate having coolant inlet/outlet ports route through the bottom or wall of the plastic portion of the tray, facing outside the enclosure. Such a design saves space for internal RESS components and limits access of coolant to sensitive components within the internal volume of the battery enclosure.

In certain embodiments, the overmolded outer part of the battery tray is formed from a glass-fiber reinforced plastic injection/compression molded resin. Injection or compression molding enables more design and process freedom for use of irregular shapes, deep features, local thickening/thinning, co-molded hardware, and integrated crossmembers all as a single part/process.

Certain embodiments provide an integrated cold plate and structural tray for maximum part count reduction and z-height efficiency. Using this proposed construction, the RESS tray can have a single cold plate over-molded into the base for a pack-level cooling approach, or it can have multiple smaller cold plates over-molded into the base to enable independent cooling of separate cell stacks.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for cooling a battery, the method comprising:
locating a metal cold plate in a mold, wherein the metal cold plate includes an internal channel;
filling the mold with resin and cooling to form an overmolded battery tray including an outer part surrounding the metal cold plate; wherein the overmolded battery tray has a bottom surface formed by the outer part and an upper surface formed by the metal cold plate;
connecting the internal channel with a coolant supply;
locating the battery on the metal cold plate; and
attaching a cover to the overmolded battery tray to enclose an internal volume, wherein the battery is in the internal volume.

2. The method of claim 1, further comprising forming the metal cold plate via a brazing process.

3. The method of claim 1, wherein:
the metal cold plate includes a coolant inlet and a coolant outlet;
the internal channel extends from the coolant inlet to the coolant outlet; and
after forming the overmolded battery tray, the internal channel extends through the outer part, extends out of the outer part to the coolant inlet, and extends out of the outer part to the coolant outlet.

4. The method of claim 3, wherein the outer part includes sidewalls and a bottom base member interconnecting the sidewalls, wherein the internal channel extends through the bottom base member, extends out of the bottom base member to the coolant inlet, and extends out of the bottom base member to the coolant outlet.

5. The method of claim 3, wherein the outer part includes sidewalls and a bottom base member interconnecting the sidewalls, wherein the internal channel extends through and out of one of the sidewalls to the coolant inlet and extends through and out of one of the sidewalls to the coolant outlet.

6. The method of claim 1, wherein the resin comprises a glass fiber reinforced thermoset or thermoplastic.

7. The method of claim 1, wherein:
the metal cold plate comprises a first metal cold plate including a first internal channel and a second metal cold plate including a second internal channel;
the battery includes a first battery and a second battery; and
locating the battery on the metal cold plate comprises locating the first battery on the first metal cold plate and locating the second battery on the second metal cold plate.

8. The method of claim 7, wherein connecting the internal channel with a coolant supply comprises connecting the first internal channel with the coolant supply and connecting the second internal channel with the coolant supply.

9. The method of claim 7, wherein connecting the internal channel with a coolant supply comprises interconnecting the first internal channel and the second internal channel and connecting the first internal channel with the coolant supply.

10. The method of claim 7, wherein filling the mold with resin and cooling forms the outer part with a central wall located between the first metal cold plate and the second metal cold plate.

11. A battery enclosure system comprising:
a tray including an overmolded outer part and a metal cold plate inner part, wherein the overmolded outer part defines an exterior surface of the tray and an annular portion of an interior surface of the tray, wherein the metal cold plate inner part defines a central portion of the interior surface of the tray, wherein the metal cold plate inner part defines a coolant flow channel extending from a coolant inlet to a coolant outlet, and wherein the coolant inlet and the coolant outlet extend through the overmolded outer part to the exterior surface of the tray;
a cover sealed to the tray to define an enclosed chamber; and
a battery located in the enclosed chamber in contact with the metal cold plate inner part.

12. The battery enclosure system of claim 11, wherein:
the metal cold plate inner part is a first metal cold plate inner part;
the central portion is a first central portion;
the battery is a first battery;
the tray includes a second metal cold plate inner part defining a second central portion of the interior surface of the tray; and
the battery enclosure system further comprises a second battery located in the enclosed chamber in contact with the second metal cold plate inner part.

13. The battery enclosure system of claim 12, wherein:
the first metal cold plate inner part is formed with the coolant inlet;
the second metal cold plate inner part is formed with the coolant outlet; and
the tray further comprises a coolant channel connecting the first metal cold plate inner part and the second metal cold plate inner part.

14. The battery enclosure system of claim 12, wherein:
the coolant inlet is a first coolant inlet;
the coolant outlet is a first coolant outlet;
the first metal cold plate inner part is formed with the first coolant inlet and the first coolant outlet;
the second metal cold plate inner part is formed with a second coolant inlet and a second coolant outlet; and
the second coolant inlet and the second coolant outlet extend through the overmolded outer part to the exterior surface of the tray.

15. The battery enclosure system of claim 11, wherein the overmolded outer part includes glass fiber reinforced weaves.

16. A vehicle comprising:
a battery;
a coolant supply; and
a battery enclosure system comprising:
a cover having a cover perimeter surface; and
a tray having a tray perimeter surface, wherein the tray perimeter surface is connected to the cover perimeter surface and defines an enclosed chamber, wherein the battery is located in the enclosed chamber, and wherein the tray includes an overmolded outer part and a metal cold plate inner part, wherein the overmolded outer part defines an exterior surface of the tray and an annular portion of an interior surface of the tray, wherein the metal cold plate inner part defines a central portion of the interior surface of the tray, wherein the metal cold plate inner part defines a coolant flow channel extending from a coolant inlet to a coolant outlet, and wherein the coolant inlet and the coolant outlet extend through the overmolded outer part and are connected to the coolant supply at a location outside of the enclosed chamber.

17. The vehicle of claim 16, wherein:
the metal cold plate inner part is a first metal cold plate inner part;
the central portion is a first central portion;
the battery is a first battery;
the tray includes a second metal cold plate inner part defining a second central portion of the interior surface of the tray; and
the battery enclosure system further comprises a second battery located in the enclosed chamber in contact with the second metal cold plate inner part.

18. The vehicle of claim 17, wherein:
the first metal cold plate inner part is formed with the coolant inlet;
the second metal cold plate inner part is formed with the coolant outlet; and
the tray further comprises a coolant channel connecting the first metal cold plate inner part and the second metal cold plate inner part.

19. The vehicle of claim 17, wherein:
the coolant inlet is a first coolant inlet;
the coolant outlet is a first coolant outlet;
the first metal cold plate inner part is formed with the first coolant inlet and the first coolant outlet;
the second metal cold plate inner part is formed with a second coolant inlet and a second coolant outlet; and
the second coolant inlet and the second coolant outlet extend through the overmolded outer part to the exterior surface of the tray.

20. The vehicle of claim 16, wherein the overmolded outer part includes glass fiber reinforced weaves.
